(19) United States
(12) Patent Application Publication
(10) Pub. No.: US 2011/0213789 A1
(43) Pub. Date: Sep. 1, 2011

(54) SYSTEM, METHOD AND COMPUTER PROGRAM PRODUCT FOR DETERMINING AN AMOUNT OF ACCESS TO DATA, BASED ON A ROLE

(75) Inventors: Kedar Doshi, Palo Alto, CA (US); Alfred Vieira, Oakland, CA (US); Chaitanya Bhatt, Fremont, CA (US); Yongsheng Wu, Redwood City, CA (US); Yanik Grignon, Newton, MA (US)

(73) Assignee: salesforce.com, inc., San Francisco, CA (US)

(21) Appl. No.: 13/037,249

(22) Filed: Feb. 28, 2011

Related U.S. Application Data
(60) Provisional application No. 61/308,750, filed on Feb. 26, 2010.

(51) Int. Cl. G06F 17/30

(52) U.S. Cl. 707/754; 707/E17.059

(57) ABSTRACT

In accordance with embodiments, there are provided mechanisms and methods for determining an amount of access to data, based on a role. These mechanisms and methods for determining an amount of access to data, based on a role can enable enhanced data security, more relevant data display, increased time savings, etc.

### CLAIM OF PRIORITY

This application claims the benefit of U.S. Provisional Patent Application 61/308,750, entitled “Category Access,” by Doshi et al., filed Feb. 26, 2010 (Attorney Docket No. SFC1P064+/176PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to data access, and more particularly to managing access to data.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Conventional systems (e.g., multi-tenant on-demand database systems, etc.) commonly allow for access of data on the systems by users associated with the systems. For example, a user of the system may be able to view data on the system by logging into the system. Unfortunately, techniques for controlling the system data that is presented to the user have been associated with various limitations.

Just by way of example, traditional methods of presenting system data to a user may fail to take into account a role of the user and may present data to the user that the user is not privileged to see. In another example, a user may have to navigate a large volume of data displayed by a system in order to view data relevant to the user. Accordingly, it is desirable to provide techniques that improve the display of relevant and authorized data to users of a system.

### BRIEF SUMMARY

In accordance with embodiments, there are provided mechanisms and methods for determining an amount of access to data, based on a role. These mechanisms and methods for determining an amount of access to data, based on a role can enable enhanced data security, more relevant data display, increased time savings, etc.

In an embodiment and by way of example, a method for determining an amount of access to data, based on a role is provided. In one embodiment, a role of a user of a multi-tenant on-demand database system is identified. Additionally, it is determined which data of the multi-tenant on-demand database system can be accessed by the user, based on the role. Additionally, a presentation of the data of the multi-tenant on-demand database system to the user is filtered, based on the data that can be accessed by the user.

While one or more implementations and techniques are described with reference to an embodiment in which determining an amount of access to data, based on a role is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for determining an amount of access to data, based on a role, in accordance with one embodiment;

FIG. 2 illustrates an exemplary relationship diagram between a role hierarchy and category groups within a system, in accordance with another embodiment;

FIG. 3 illustrates an exemplary hierarchy diagram, in accordance with another embodiment;

FIG. 4 illustrates an exemplary category group hierarchy, in accordance with another embodiment;

FIG. 5 illustrates a block diagram of an example of an environment wherein an on-demand database system might be used; and

FIG. 6 illustrates a block diagram of an embodiment of elements of FIG. 4 and various possible interconnections between these elements.

### DETAILED DESCRIPTION

### General Overview

Systems and methods are provided for determining an amount of access to data, based on a role.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for determining an amount of access to data, based on a role will be described with reference to example embodiments.

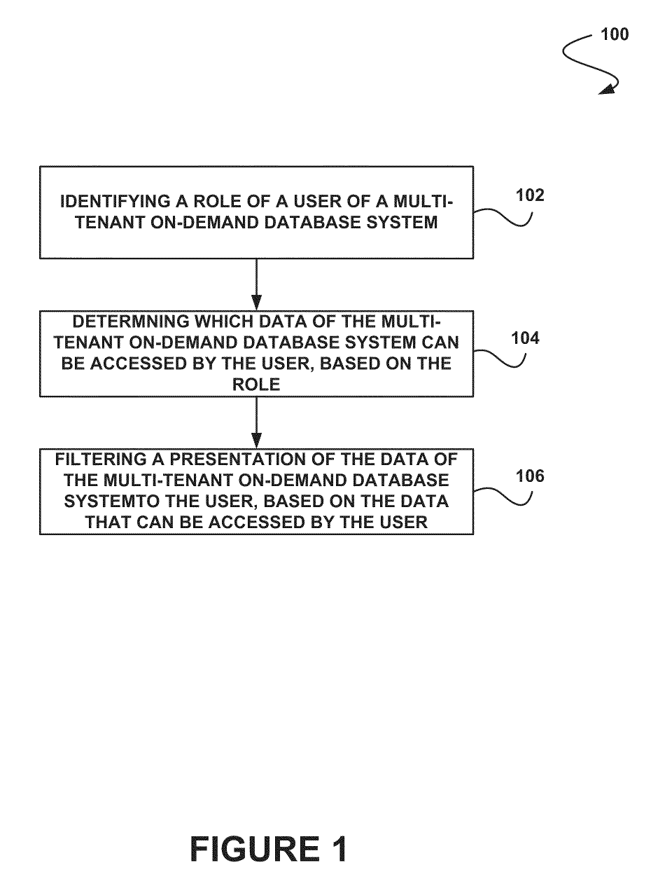

FIG. 1 illustrates a method 100 for determining an amount of access to data, based on a role, in accordance with one embodiment. As shown in operation 102, a role of a user of a multi-tenant on-demand database system is identified. In one embodiment, the user may include a client of the multi-tenant on-demand database system (e.g., a customer of the multi-tenant on-demand database system, etc.). In another embodiment, the user may include one of a plurality of entities of a client of the multi-tenant on-demand database system (e.g., an employee of a client of the multi-tenant on-demand database system, etc.).

Additionally, in one embodiment, the role of the user may include a position held by the user. For example, the user may be associated with a company, and the role of the user may include the position held by the user at the company (e.g., chief executive officer (CEO), vice president, director, etc.). In another embodiment, the role of the user may include a division of the company associated with the user. For example, the role of the user may include vice president of marketing, vice president of development, director of engineering, etc.

In yet another embodiment, the role of the user may be part of a role hierarchy structure. For example, the role of the user may be part of a structure intended to reflect an organizational structure of the company. Additionally, in another embodiment, the role of the user may be managed by the system. For example, the role hierarchy structure may be tied to the system in order to manage organizational roles for one or more customers.

Further, in still another embodiment, the role of the user may be determined when the user logs into the multi-tenant on-demand database system. For example, an identifier associated with the user that includes the role of the user may be submitted to the multi-tenant on-demand database system when the user logs on to the system. Of course, however, the role of the user may be identified in any manner. Additionally, in another embodiment, the user may log into the multi-tenant on-demand database system via a portal (e.g., an Internet portal, etc.).

Additionally, it should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Furthermore, as shown in operation 104, it is determined which data of the multi-tenant on-demand database system can be accessed by the user, based on the role. In one embodiment, the data of the multi-tenant on-demand database system may be stored within the multi-tenant on-demand database system. For example, the data may include a plurality of records within a knowledge base of the multi-tenant on-demand database system (e.g., as part of a service cloud), an idea base of the multi-tenant on-demand database system, a community database of the multi-tenant on-demand database system, etc.

In another embodiment, the data of the multi-tenant on-demand database system may be grouped. For example, the data of the multi-tenant on-demand database system may be organized into one or more category groups, dimensions, etc. For instance, the data may be grouped by geography, by product, etc. Further stilt in one embodiment, the data of the multi-tenant on-demand database system may be hierarchically arranged within one or more groups. For example, the plurality of records stored within the multi-tenant on-demand database system may exist in a hierarchical structure and may each hold a position of a hierarchy within the multi-tenant on-demand database system. In this way, the data of the multi-tenant on-demand database system may be segmented into organized hierarchical categories that are relevant to users who should view the data.

Also, in one embodiment, it may be determined which data can be accessed by the user by identifying one or more associations between the role and one or more portions of the data. For example, the role of the user may be associated with a tag, and one or more data elements (e.g., records, etc.) within the multi-tenant on-demand database system may include the tag associated with the role of the user. Additionally, it may be determined that the user can access a data element if the data element includes the tag associated with the role of the user. In this way, data access may be established by binding the role of the user to a record located at a particular position in a hierarchical category.

Furthermore, in another embodiment, the user's access to the data of the multi-tenant on-demand database system may be configured. For example, an administrator (e.g., an administrator of a company employing the user) may configure associations between the role of the user and one or more categories within one or more groups of the data. Additionally, in another embodiment, associations between the role of the user and one or more categories within the one or more groups may be created and stored in a mapping table. In yet another embodiment, user access to one portion of data may be affected by user access to another portion of data. For example, the data that can be accessed by the user may be determined by determining an exclusive combination of category groups of the data that include the tag associated with the user. In this way, the user's data access may be constrained by requiring a match across category groups that can be accessed by the user.

Also, in one embodiment, one or more rules may apply to the relationship between the data accessible by the user and the role of the user. For example, a first amount of data accessible by a first user may not be greater than a second amount of data accessible by a second user with a role higher than the role of the first user within a role hierarchy. In another example, within a role hierarchy, associations between the role of a parent user and one or more categories within one or more groups of the data may be inherited by subordinate roles within the role hierarchy as a default. For instance, when configuring associations between a corporate role hierarchy and a plurality of category groups, an administrator may configure one or more associations between the role of CEO and a plurality of category groups. Additionally, this configuration for the role of CEO may automatically be assigned to subordinate roles in the corporate role hierarchy, such as VP, director, etc. In this way, associations between the corporate role hierarchy and the plurality of category groups may be set up rapidly.

In yet another example, the role of the user may be given or denied access to specific portions of the data of the multi-tenant on-demand database system. For instance, if an administrator desires to create a set of data that is only accessible by a particular role, the administrator may create a category croup containing the set of data and may only give permission to the category group to the role. Further, in another example, a category group associated with the role of the user may restrict another category group associated with the role of the user. For example, if a user role has access to a product category group, and the user role also has access to a particular geographical region in a geography group, then the product category group may be limited to the particular geographical region in the geography group.

Further still, as shown in operation 106, a presentation of the data of the multi-tenant on-demand database system to the user is filtered, based on the data that can be accessed by the user. In one embodiment, presenting the data to the user may include displaying the data to the user (e.g., utilizing a user interface (UI), an Internet portal, etc.). In another embodiment, presenting the data to the user may include allowing the user to perform one or more actions on the data. For example, the user may be able to edit the data, delete the data, etc.

In yet another embodiment, the presentation of the data of the multi-tenant on-demand database system may be filtered by only presenting to the user the data that can be accessed by the user. In this way, only portions of the data of the multi-tenant on-demand database system that are relevant to the user may be presented to the user, thereby improving the user's experience while navigating data of the system. Additionally, the user may not be able to access portions of data of the multi-tenant on-demand database system that they are not authorized to view, thereby strengthening the security of the system.

Additionally, in another embodiment, the user may include a high-volume portal user (e.g., a customer with a high volume of users, etc.). Further, it may be determined which data may be accessed by the high volume portal user without accessing a role of the high-volume portal user.

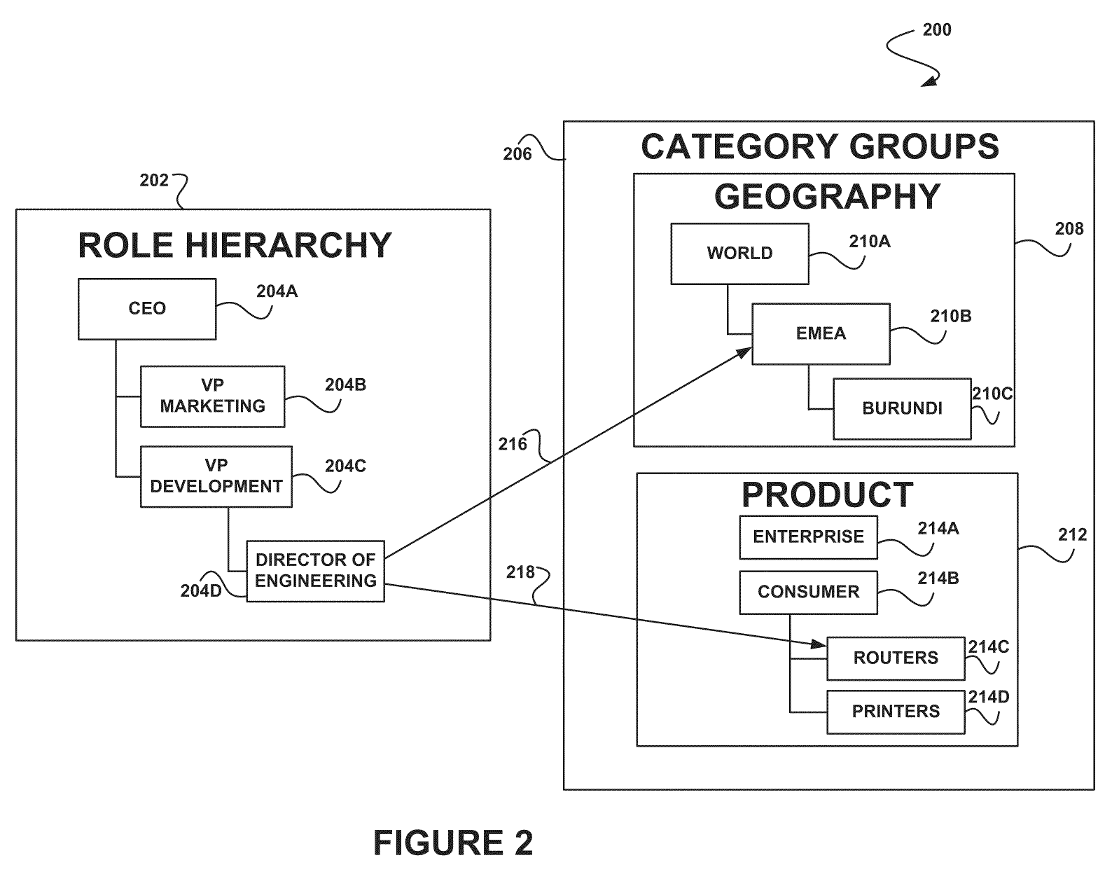

FIG. 2 illustrates an exemplary relationship diagram 200 between a role hierarchy and category groups within a system, in accordance with another embodiment. As an option, the present diagram 200 may be carried out in the context of the functionality of FIG. 1. Of course, however, the diagram 200 may be carried out in any desired environment. The aforementioned definitions may apply during the present description.

As shown, a corporate role hierarchy 202 for a client corporation is divided into individual hierarchically arranged roles 204A-D. Additionally, a plurality of category groups 206 includes a geography group 208 that contains hierarchically arranged geographical areas 210A-C. The plurality of category groups 206 further includes a product group 212 that contains hierarchically arranged products. In one embodiment, the corporate role hierarchy 202 and the category groups 206 may be stored in a multi-tenant on-demand database system.

Additionally, the role of director of engineering 204D is given permission 216 to access the geographical area of Europe, the Middle East, and Africa (EMEA) 210B as well as permission 218 to access consumer router products 214C. In one embodiment, permission 216 to access the geographical area of EMEA 210B may be established by including a tag associated with the director of engineering role 204D within the geographical area of EMEA 210B. Likewise, permission 218 to access the consumer router products 214C may be established by including a tag associated with the director of engineering role 204D within the consumer router products 214C.

In this way, when a director of engineering for the client corporation accesses the knowledge base of the system (e.g., logs onto a portal of the system, etc.), they may access (e.g., view, etc.) an exclusive combination of the data associated with their role within the category groups 206, which may include all consumer routers within the EMEA geographical range.

In another embodiment, administrator users may specify category access rules at the user node level by listing for each dimension type the list of category nodes visible to the users in the user node. These access rules may be consumed by the query builder and a plsql access checker to constrain the set of articles visible to users at each node. Additionally, in yet another embodiment, the relationship between the role hierarchy and the category groups may be provided by a CategoryAccess entity, which may include a UserNode to DataNode mapping table. A list of these rows for each UserNode may defines the set of visible categories.

Further, in another embodiment, CategoryAccess rows may be cached at the UserNode level. Further still, for each role, the inherited access rows may be cached. In this way, even if a role doesnt explicitly have access to a category but inherits access from its parents, it may have an entry in the cache. Also, in one embodiment, a plsql access checker may take a list of entity ids and verify if those entities are visible to the context user. For example, to be visible, an article may have to be categorized at a parent or child of the nodes for each of the dimension types configured at the UserNode.

In addition, in another embodiment, for category_types that the role has access to, articles may be categorized either at, above, or below the categories defined for the role, and for all category_types that are defined for the entity, but that the role does not have access to, the article may have to be uncategorized. Both these conditions may have to be met for access to an article to be allowed.

Furthermore, in one embodiment, one or more maintenance routines may be utilized within the system. For example, an insert category access routine may be is bulkified and may be identified by the variable nonbulkinsertable=“no”. It may perform a plurality of checks (e.g., category_type defined for this entity, category in category type, bosses have more access, etc.). Additionally, it may also allow downgrades (e.g., USA to CA, TX, etc.) and upgrades (e.g., SF to CA, etc.), and may clean up access rows below that role to make sure child roles never have more access than the parent. Further, in one embodiment, rows may be inserted for only one role in each batch of inserts.

In another embodiment, a role reparent routine may perform two cleanups—checking for revoke_access in the new set of boss roles and making sure the new bosses have more access than the role being reparented. In yet another embodiment, a category reparent routine may ensure that any role with access to a category ensures that its parents still have more access. In yet another embodiment, the CategoryAccess object may be hidden from a public API.

Additionally, in one embodiment, the relationship diagram 200 between the role hierarchy and the category groups within the system may be used for dimension based sharing. For example, dimension based sharing may include a model for managing record-level data security for the system. In another embodiment, dimension based sharing may form the basis for record-level security in a knowledge base product.

Additionally, dimension based sharing may include am indirect model that grants access to a hierarchical role by associating that role with one or more nodes in one or more hierarchically organized dimensions. In yet another embodiment, all of the records covered by dimension based sharing may be similarly associated with nodes in these dimension hierarchies, with the result that each role will have access rights to the records associated with the same dimension nodes to which the role itself is associated.

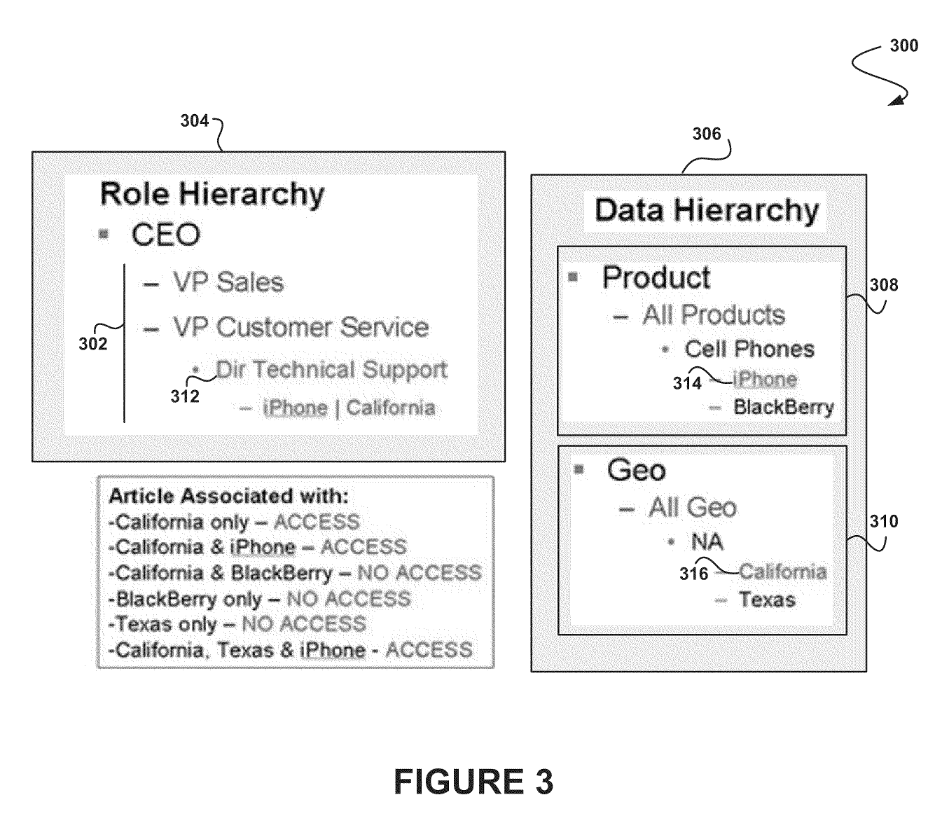

FIG. 3 illustrates an exemplary hierarchy diagram 300, in accordance with another embodiment. As an option, the present diagram 300 may be carried out in the context of the functionality of FIGS. 1-2. Of course, however, the diagram 300 may be carried out in any desired environment. The aforementioned definitions may apply during the present description.

As shown, within the hierarchy diagram 300, roles 302 are represented in a role hierarchy 304. Additionally, two dimension hierarchies 206 (product 308 and geography 310) have been created for classifying data records (e.g., articles, etc.). Further, the role “Director of Technical Support” 312 has been granted access to the iPhone node 314 of the product hierarchy 308 and the California node 316 of the geography hierarchy 310.

In one embodiment, the result of associating this role 312 with those nodes 314 and 316 in the data hierarchy may be that the director of technical support will be able to see all records that have been associated with both the iPhone node 314 of the product hierarchy 308, and the California node 316 of the geography hierarchy 310, but not records associated with iPhone or California alone. Additionally, it should be noted that the shorthand notation for an access “rule” may be shown as a list of values within a dimension, separated by commas, with dimensions separated by a vertical bar (“|”).

In one embodiment, within a knowledge base infrastructure, dimension based sharing may provide an administrator with the ability to control access to articles, so that users of the system may only see the information that they should be allowed to see according to the policies of the organization. Additionally, dimension based sharing may provide the configuration-time components for granting access and persisting these grants over time (e.g., a UI and/or Metadata API etc.), the run time components for assuring that these access grants are respected as users are navigating the knowledge base, and the maintenance components for ensuring that these grants continue to obey the policies of the organization across changes to either the user role hierarchy or the various category type hierarchies.

Additionally, in another embodiment, access grants configured for a role by the administrator may be interpreted broadly, so that they will apply not only to the category directly selected for the grant, but also to all the child and parent nodes on the same branch of the category group hierarchy as the granted category. This may ensure that the directly granted category may provide a default focus that can be used by the knowledge base presentation layer to initially present the most relevant information to the customer. Additionally, in yet another embodiment, the access to parents and children of the directly granted category may ensure that the customer may not be too narrowly restricted in the range of articles that they can see, and may be able to browse either more general or more specific articles that may provide the information they are seeking.

Table 1 illustrates configuration-time use cases for administrators who need to grant access rights to articles for other users of the system, and the run-time use cases for ensuring that users are only presented with the articles to which they have been granted access when using a knowledge base. Of course, it should be noted that the use cases shown in Table 1 is set forth for illustrative purposes only, and thus should not be construed as limiting in any manner.

TABLE 1

| | User | | |
|---|---|---|---|
| Use Case | Type | Description | Suggested UI |
| Grant access | Admin | Administrator may have the ability | Location |

| | | |
|---|---|---|
| to one or more | to view the current access settings | Setup \| Manage Users \| |
| categories of | for each Category Group on the | Roles \| Role Detail |

| | | | |
|---|---|---|---|
| Articles to a | | Role Detail page for each Role in | Related list on Role Detail page of |
| Role | | the Role Hierarchy | Category Groups, showing high- |
| | | Administrator may have the ability | level summary of access for the |
| | | to select a Catetgory Group to view | Role |
| | | details on access for the Role | Category Group Detail page |
| | | Administrator may have the ability | showing details of the access |
| | | to edit access settings for the Role | configured for the Role |
| | | On save, mapping a Role to | Category Group Edit page allowing |
| | | Categories within a Category | the Administrator to change access |
| | | Group may grant access to | for the Role, including a Hierarchy |
| | | members of that Role to Articles | browser with multi-selection of |
| | | associated with those Categories, | Category nodes for granting access |
| | | and also to Articles associated with | to articles tagged at those nodes |
| | | the parent and child Categories on | |
| | | the same hierarchy branches as the | |
| | | selected Categories | |
| Revoke access | Admin | Administrator may have the ability | Location |

| | | |
|---|---|---|
| to a Category | to view the current access settings | Setup \| Manage Users \| |
| Type from a | for each Category Group on the | Roles \| Role Detail |

| | | | |
|---|---|---|---|
| Role | | Role Detail page for each Role in | Related list on Role Detail page of |
| | | the Role Hierarchy | Category Groups, showing high- |
| | | Administrator may have the ability | level summary of access for the |
| | | to select a Catetgory Group to view | Role |
| | | details on access for the Role | Category Group Detail page |
| | | Administrator may have the ability | showing details of the access |
| | | to edit access settings for the Role | configured for the Role |
| | | On save, mapping a Role to | Category Group Edit page allowing |
| | | Categories within a Category | the Administrator to specify that the |
| | | Group may grant access to | Role should not have access to any |
| | | members of that Role to Articles | Categories within the Category |
| | | associated with those Categories, | Group |
| | | and also to Articles associated with | |
| | | the parent and child Categories on | |
| | | the same hierarchy branches as the | |
| | | the selected Categories | |
| Grant access | Portal | Permissions may be granted at the | Expandable hierarchy of |
| to one or more | Admin | Portal Account level and apply to | classification Dimensions with |
| categories of | | all users under that Account | checkboxes at each node for |
| Articles to | | Portal Administrator may have the | granting access to articles tagged at |
| Light Portal | | ability to select multiple values at | that node |
| Users | | different levels of hierarchy from | |
| | | multiple dimensions that have been | |
| | | used to categorize Articles | |
| | | For each Value, Administrator may | |
| | | be able to select a level of access | |
| | | for Articles tagged with that Value | |
| | | (R/O, R/W, R/W/D, R/W/D/T) | |
| | | Selecting these values and saving | |
| | | the settings may create a permission | |
| | | for the Group to access Articles | |
| | | tagged with the selected values | |
| Inherit access | Any user | At run time, user may enter a | When viewing the Category Group |
| to one or more | | search on Articles, view a list or | access summary on the Role Detail |
| categories of | | Related List of Articles, view a | page, the Role from which the |
| Articles from | | report on Articles, or attempt to | current Role inherits settings may be |
| a parent Role | | view a single Article | displayed. |
| | | The user's Role may be checked for | When viewing the Category Group |
| | | Article access | access details on the Category |
| | | If there are no Article access | Group detail page, the specific |
| | | settings for the user's Role, the Role | Category branches included in the |
| | | Hierarchy may be searched | inherited access rights may be |
| | | upwards of the user's Role until a | displayed. |
| | | Role with access settings is found | When editing the Category Group |
| | | The access settings of that parent | access details, the Role from which |
| | | role may be used to determine | the current Role inherits settings |
| | | which Articles will be displayed as | will be displayed, and if the |
| | | Search results, included in a List | Administrator chooses to customize |
| | | View or Related list, included in the | these settings, the Category selector |
| | | data set for a Report. The settings | may only display those Categories |
| | | may also be used to determine if the | that are included in the access rights |
| | | user can open and read an Article to | inherited by the current Role. The |
| | | which they have been able to | Administrator may only be able to |
| | | navigate | set sights that are more restricted |
| | | | than the rights of the parent Role. |
| Search for | Any user | User may enter a search term to | |
| article(s) in | | find relevant KB articles | |
| the | | User's Role may be checked for | |
| Knowledge | | Article access and search result set | |
| Base | | is filtered to present only Articles to | |
| | | which the user has access | |
| View | Any user | User may view a record that has a | |
| article(s) in a | | related list of Articles | |
| related list | | Before displaying the related list of | |
| | | Articles, user's Role may be | |
| | | checked for Article access and set | |
| | | of items returned by the related list | |
| | | is filtered to present only Articles to | |
| | | which the user has access | |
| View | Any user | User may navigate to a list view | |
| article(s) in a | | page of KB articles | |
| list view page | | User's Role may be checked for | |
| | | Articles access and set of items | |
| | | returned by the list is filtered to | |
| | | present only Articles to which the | |
| | | user has access | |
| View a report | Any user | When viewing a report on Articles, | |
| on Articles | | user's Role may be checked for | |
| | | Article access, and report results | |
| | | may be filtered to include only | |
| | | Articles to which the user has | |
| | | access | |
| Read an | Any user | User may follow a link to view an | |
| Article | | Article | |
| | | Before displaying the Article, user's | |
| | | Role may be checked for Article | |
| | | access | |
| | | If the user has access, the Article | |
| | | may be displayed | |
| | | If the user does not have access, a | |
| | | standard “insufficient permissions” | |
| | | page may be displayed | |

In another embodiment, rules may exist for setting access to categories within category groups. For example, the set of rules may clarify the visibility to be provided by access grants under various conditions of access rights provided to the user, and associations of an article with various categories and category types. In another embodiment, in the knowledge base one purpose may be to disseminate information, so access is standard, and specific grants may serve to narrow down the user's access rather than broaden it. These principles may uphold the default expectation that information should be available, while still providing the ability to grant more focused access where appropriate, and greatly simplifying administration of access.

Table 2 illustrates rules for setting access to categories within category groups. Of course, it should be noted that the rules shown in Table 2 are set forth for illustrative purposes only, and thus should not be construed as limiting in any manner.

TABLE 2

The default access to a category group may be “no access”
A role may not have access greater than a parent role
(higher than it on the role hierarchy)
If a role does not have access to a category group,
the role may only have access to articles that are
not categorized on that category group
When a role has been granted access to a category
on any branch of a category group, the role may be
able to see articles associated with that category,
and with all its parent and child categories on the
same branch of that category group
When a role has been granted access to a category
on any branch of a category group,
they may not be able to see articles associated with
categories on other branches of that
category group, unless they have additional direct
grants of access to those other branches
(or within category groups)
When a role has been granted access to particular
branches on more than one category
group, they may be able to see articles that have
been categorized to those branches on
both category groups (and across category groups)

Table 3 illustrates an administrative flow for setting access within a category group. Of course, it should be noted that the administrative flow shown in Table 3 is set forth for illustrative purposes only, and thus should not be construed as limiting in any manner.

TABLE 3

| 1. | In one embodiment, no role may have access greater | |
|---|---|---|
| | than its parent role, so provision of access may | |
| | needs to start with the top user role. | |
| 2. | A user may default all the top roles to | |
| | “all categories” when creating a new | |
| | category group. | |
| 3. | For these top roles, the administrator may: | |
| | 1. | Leave the access setting at “all categories” |
| | | to set that as the inherited default for |
| | | all roles. |
| | 2. | Choose “none” to remove access to the |
| | | category group from all roles. |
| | 3. | Choose “custom” to select some subset of |
| | | “all categories” to be the inherited de- |
| | | fault for all roles. |
| 4. | All roles may inherit the level of access set for the | |
| | top role until more restrictive settings | |
| | are configured at some lower point in the hierarchy. | |
| 5. | For roles below the top role, the default setting may | |
| | be to inherit the settings of the closest parent | |
| | role that has a setting of “none” or “custom.” | |
| 6. | For roles below the top role, an administrator may: | |
| | 1. | Leave the access setting at “inherited from . . . ” |
| | | to accept the inherited settings |
| | 2. | Choose “none” to remove access to the category |
| | | group from the current role and all its children. |
| | 3. | Choose “custom” to select some subset of the |
| | | inherited categories for the current role and all its children. |

| | |
|---|---|
| 7. | When the administrator chooses “custom” for a role, |
| | the Category tree component may display only the branches and |
| | categories inherited from the parent role. In this way, the |
| | administrator may be able to de-select some of the categories |
| | to make access more restrictive for the current role and all |
| | of its children, but may not be able to configure access |
| | rights greater than those of a parent role. |

Table 4 illustrates additional features for dimension based sharing. Of course, it should be noted that the additional features shown in Table 4 are set forth for illustrative purposes only, and thus should not be construed as limiting in any manner.

TABLE 4
The ability to create user dimensions other than the existing role hierarchy.
The conversion of the existing role hierarchy to the new dimensions
data structures.
Support for entity types other than articles.
The ability to control, on an entity type and dimension basis, the
interpretation of the scope of access rights to categories, that is, whether
explicit access rights to a category node will be interpreted as including
child categories of the designated node, parent categories, both, or neither.
Support for both multiple selection and multiple position modes of
associating roles with categories within category types.

In another embodiment, in order for dimension based sharing to implement the use cases and design principles described above, the following specific functions may be supported. Some of these functions may implement the UI and the metadata API that allows an administrator or developer to configure access rights to articles for user roles. Others are run-time behaviors that may take advantage of the access configuration data to determine which filtering settings and articles a user should see when navigating to various pages in the knowledge base UI.

Table 5 illustrates functions that may allow an administrator to grant access rights to articles for roles. Of course, it should be noted that the functions shown in Table 5 are set forth for illustrative purposes only, and thus should not be construed as limiting in any manner.

TABLE 5
Administrator selects a role for which they want to grant access to Articles

The Administrator may use the existing role hierarchy pages (tree view, list view, or sorted list view) to
locate the role to which they want to grant access. Clicking on the Role name may take the Administrator to
the Role Detail page, where they start the process of granting access.

Administrator chooses a Category Group to which they want to assign permissions for the selected Role(s)

When the customer has the Knowledge Base product installed, the Role Detail page may contain a new list
element under the “Users in this Role” related list, named “Article Category Group Settings”. This list may
display all of the Category Groups that have been configured for Articles in the org. Because access may be
defined for each Category Group independently, the first step for the Administrator may be to select one of
the existing Category Groups. To guide the Administrator in making this selection, the list may present the
following:

The full set of Category Groups
For each Category Group, an Edit link in the Action column that allows the Administrator to go
directly to the Edit page for the Category Group Settings for that Category Group
For each Category Group, the Category Group name, with a link to a Detail page that displays the
current access settings for that Category Group
For each Category Group, a short description of the current level of access, which may be one of
the following:

None, to indicate that the Role - and its children that don't have their own settings - have no access
to Categories within the Category Group
All, to indicate that the Role - and its children that don't have their own settings - has access to all
the Categories within the Category Group
Custom, to indicate that the Role - and its children that don't have their own settings - has access
to a specific set of Categories within the Category Group
Inherited from [Parent Role Name], to indicate that this role inherits its access settings from
another role higher up in the Role Hierarchy

A link in the list title bar that may take the user to a general help topic explaining the process for setting
access rights for Roles to Categories within Category Groups
On this page, Administrator may:
Click on the name of a Category Group, which may take them to Category Group Settings detail page
for that Role, or
Click on the “Edit” link in the Action column, which may take them to the Edit Category
Group Settings page for that Role

Administrator views the existing access settings for a Category Group

If the Administration clicks on any of the Category Group names on the Role Detail page, they may be taken
to a Read-Only page displaying the current access settings for the Role to that Category Group. This page
may contain the following:

The Name and Description of the Category Group
A “Help for this Page” link in the page title bar that leads to a help topic explaining what the
Administrator can do on this page.
A Category Access setting that displays information about the current access settings for the Role to
Categories within this Category group, which may be one of the following:

If the Role has access to All Categories, either set directly at the Role level or inherited from a
parent Role, the Access may be displayed as “All” with an explanatory sentence that reads
“Members of this role can access all Articles associated with any Category in this Category Group”
If the Role has no access to the Category Group, either set directly at the Role level or inherited
from a parent Role, the Access with be displayed as “None”, with an explanatory sentence that reads
“Members of this role cannot access any Articles associated with this Category Group”
If the Role inherits Custom access settings from a parent Role, the Access may be displayed as
“Inherit from [Name of parent Role from which access is inherited]” with an explanatory sentence
that reads “Members of this role can access Articles associated with Categories in these branches,
and their children”. Below this summary information, each Category to which the role has either
been directly granted access, or to which its parent role has been directly granted access, may be
listed on its own line, preceded by all the parent Categories on the same branch of the hierarchy
above the directly granted Category. Child categories may not be shown because of the possibility of
further branching below the level of the directly granted Category. The explanatory sentence serves
the purpose of making clear that child Categories are included in the access grant.
If the Role has Custom access settings directly granted to it, the Access may be displayed as
“Custom” with an explanatory sentence that reads “Members of this role can access Articles
associated with Categories in these branches, and their children”. Below this summary information,
each Category to which the role has been directly granted access may be listed on its own line,
preceded by all the parent Categories on the same branch of the hierarchy above the directly granted
Category. Child categories may not be shown because of the possibility of further branching below
the level of the directly granted Category. The explanatory sentence serves the purpose of making
clear that child Categories are included in the access grant.

An “Edit” button in the header bar of the Category Group Settings section that takes the Administrator to
the Edit page for the Category Group, where they can change access settings for the Role.

Administrator edits the existing access settings for a Category Group

The Administrator can navigate to the Edit page for Category Group access settings either by clicking on
the Edit link for the appropriate Category Group on the Role Detail page, or from clicking the Edit Button
on the Category Group Detail page. On this page, the Administrator has three main choices for defining
access, which are slightly different for Roles at the top level of the Hierarchy than for all other Roles in the
Hierarchy.

When the Administrator is configuring access for a Role at the top level of the Hierarchy, their
choices are:

“All Categories” - selecting this may provide the Role (and all its children that do not have their
own settings) access to all Categories within the Category Group.
“None” - selecting this may revoke access to the entire Category Group from the Role (and all its
children that do not have their own settings)
“Custom” - selecting this may display the Category selection panel and allow the Administrator to
select and grant access to specific Categories within the Category Group for the Role (and all its
children that do not have their own settings)

When the Administrator is configuring access for a Role at any other level of the Hierarchy, their
choices are:

“Inherit from [“Name of parent role from which settings are inherited]” - selecting this may
provide the Role (and all its children that do not have their own settings) access to the same Categories
that have been granted to the parent role from which it inherits its settings.
“None” - selecting this may revoke access to the entire Category Group from the Role (and all its
children that do not have their own settings)
“Custom” - selecting this may display the Category selection panel and allow the Administrator to
select and grant access to specific Categories within the Category Group for the Role (and all its
children that do not have their own settings)

Whenever the Administrator changes from one of these types of access to another, before the change is
made the system may display a warning informing them that the changes may be effective not only for the
Role being edited, but also may affect children of the Role. This may be a standard “OK/Cancel” dialog -
if the Administrator chooses “OK” the new setting maybe effective and if they choose “Cancel” the setting
may not be changed.

Administrator uses the Category Selection Panel to define custom access for the Role

When the Administrator chooses “Custom” to define specific categories for this Role, the Category
selection panel may be displayed, which may have the following features and behaviors:
A selection component that displays the Categories in the Category Group in an expandable tree format

To prevent the Administrator from granting the Role access greater than that of its parents in the
Role Hierarchy, the Category Tree may show only the branches of the Category Group, and the
Categories within those branches, that are available to the immediate parent of the Role being edited
The levels of the Category tree can be expanded and collapsed
The Category Tree may be scrollable if more Categories are expanded than may fit in the window
The Category Tree may have a “Quick Find” feature that may allow the Administrator to enter a
search term, and jump directly to a matching Category in the tree
The Administrator may be able to indicate the Categories desired for selection by clicking on them
to highlight them in the Category tree

A list of currently selected Categories for the Role

Each of the items in the Selected Categories list may be accompanied by a “Delete” icon. The
Administrator can click on this icon to revoke access to any of the currently selected Categories.

A “Select” button which, when clicked by the Admin, may add Categories highlighted by the administrator
in the selection component to the list of currently selected Categories.
Save and Cancel buttons that may allow the Administrator to Save their access settings, or Cancel out of
editing the Settings for the Role and return to the previous page

Administrator saves access settings for the Category Group

Once all Category selections for a particular Category type have been made, the Administrator may click
“Save” to record the access settings for the Roles to Categories within that Category Group.

Before the settings are saved, the system may check the table storing the structure of the Category
Group to make sure that it is not locked for editing by another process. If the table is locked, the
system may return an error to the user indicating that another user is editing the Category Group, and
they may have to try to save their settings later. Once the table is no longer locked, the Administrator
may be allowed to save the settings
These settings may then be recorded in the objects/tables designed to persist the settings
Access settings must include the following data:

RoleID
EntityID
DimensionID
Revoke OR list of Categories for the Category Group

In one embodiment, when a user has been granted access to a category on any branch of a category type, they may be able to see articles associated with that category, and with all its parent and child categories on the same branch of that category type. In another embodiment, all grants of access to specific categories may be interpreted as also granting parent and child access within the same branch of the hierarchy in which the selected category resides.

Table 6 illustrates optional rules for maintaining access settings. Of course, it should be noted that the rules shown in Table 6 are set forth for illustrative purposes only, and thus should not be construed as limiting in any manner.

TABLE 6
If a Role is moved to the top level of the hierarchy, its access may be set to “All
Categories” for all Category Groups
If a Role is moved on the hierarchy in such a way that it would have more access than its
new parent Role, it may have its access trimmed to match that of the new parent, which
may trigger the trimming of its children, etc.
If a Category is removed from a Category Group, it must be removed from the access
rights of all Roles that currently have permission to access Categories on the branch from
which the Category was removed
If a Category is moved from one branch to another of a Category Group, it must be:

Removed from the access rights of all Roles that currently have permission to
access Categories on the branch from which the Category was removed

If access for a Role to a Category Group is changed from one Category to another
Category HIGHER UP on the same branch, it may NOT force a change to any child Role
that has direct settings to a Category farther down on the same branch
If access for a Role to a Category Group is changed from one Category to another
Category LOWER DOWN on the same branch, and this would result in a child Role with
direct settings to that branch having a higher level of access than the parent Role, the
access rights of the child Role may be trimmed to match those of the parent Role

Table 7 illustrates optional rules for inheriting access settings. Of course, it should be noted that the rules shown in Table 7 are set forth for illustrative purposes only, and thus should not be construed as limiting in any manner.

TABLE 7
Child Roles may inherit the Article access grants given to their parent roles by default.
This may allow the Admin to configure access in a top-down fashion, granting broad
access to most levels, and only directly configuring access for subordinate levels when
there is a good business reason to have their access more narrowly defined than their
parents.
Accordingly, whenever a Role does not have Article access directly granted to it, that
Role may inherit the access settings of the closest parent role above it in the hierarchy
that has been directly granted access. This inheritance rule may be implemented at run-
time instead of configuration time. That is, when a particular user attempts to search the
Knowledge Base, view a list or related list of Articles, view a report, or view an
individual Article, the run time code controlling the relevant operation may:

check the Role of the user for directly granted Article access settings, and if found,
use those.
if no direct grant of access is found for the Role, examine the parent Role above it
in the hierarchy to see if that Role has an access grant configured for it.
continue this operation until a parent Role is found that does have an access grant
configured, and use that one to determine which Articles should be returned as part
of a Search, which Articles should be shown in a list or related list, which Articles
should be included in report results, or whether a particular Article should be made
available for reading or editing.

Table 8 illustrates optional rules for performing access checks. Of course, it should be noted that the rules shown in Table 8 are set forth for illustrative purposes only, and this should not be construed as limiting in any manner.

TABLE 8
The end goal of all this functionality for granting access to articles, managing inheritance
and maintaining access settings is for every user of the Knowledge Base application to
see only those Articles to which they have been granted access either directly or by
inheritance. Accordingly, the access configuration for each user may be used at run time
in access checks for the following situations:

the user performs a search on the Knowledge Base - access check is done to ensure
that search results include only Articles to which the user has been granted access
the user navigates to an Article list view page, or a mashup style page that has an
Article list view component - access check is done to filter the list to include only
Articles to which the user has been granted access
the user navigates to a page with a related list of Articles - access check is done to
filter the related list to include only Articles to which the user has been granted
access
the user runs a report whose base data is Articles - access check is done to filter the
data on which the report is based so that it only includes Articles to which the user
has been granted access
the user follows a link or otherwise attempts to read or edit an Article - access
check is done to see if the user has been granted access that includes that particular
Article; if not, the action is prevented.

These access checks themselves are not covered in the scope of Dimension Based
Sharing. Instead, other teams working on the Knowledge Base product may consume the
sharing provider(s) created for Dimension Based Sharing to perform these access checks
in their own code.

In yet another embodiment, one or more of the capabilities for granting access to articles described as user interaction with a configuration UI above may also be available as functions within the Metadata API, so that customers may configure access programmatically if they wish.

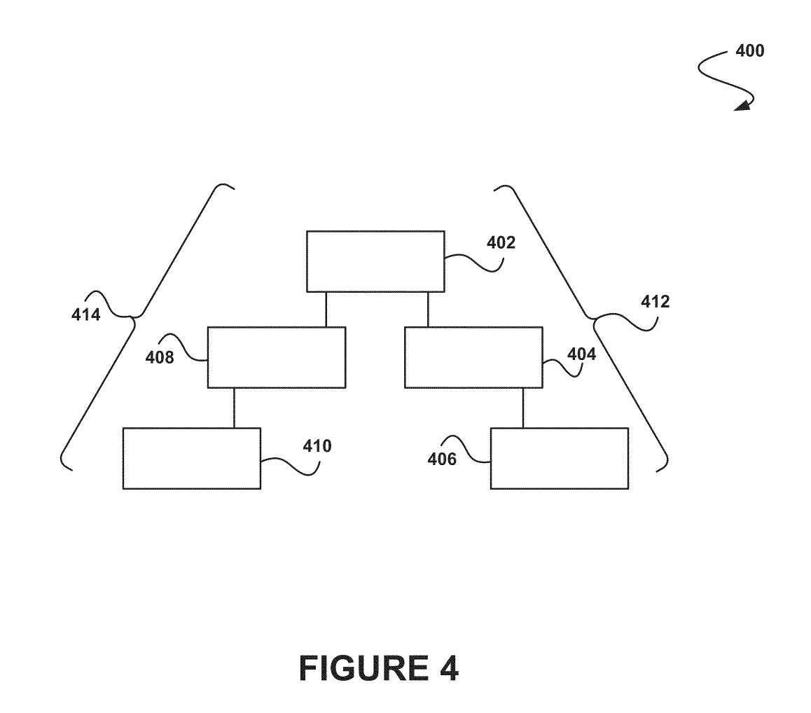

FIG. 4 illustrates an exemplary category group hierarchy 400, in accordance with another embodiment. As an option, the present hierarchy 400 may be carried out in the context of the functionality of FIGS. 1-3. Of course, however, the hierarchy 400 may be carried out in any desired environment. The aforementioned definitions may apply during the present description.

As shown, the category group hierarchy 400 includes a plurality of nodes 402-410. Additionally, nodes 402-406 in the category group hierarchy 400 constitute branch 412 of the category group hierarchy 400, and nodes 408, 410, and 402 in the category group hierarchy 400 constitute branch 414 of the category group hierarchy 400.

In one embodiment, permission may be given to a role (e.g., a role of a role hierarchy, etc.) to access node 404 of the category group hierarchy 400. For example, a tag associated with the role may be stored within the node 404. Additionally, in another embodiment, if it is detected that the role has permission to access node 404 of the category group hierarchy 400, permission to access the branch 412 that includes the node 404 within the category group hierarchy 400 may also be automatically granted to the node. For example, if it is detected that the role has permission to access node 404 of the category group hierarchy 400, permission to access nodes 402 and 406 may also be automatically granted to the node. In this way, by enabling branch permission inheritance, specific assignments to each level of the category group hierarchy 400 may be avoided.

### System Overview

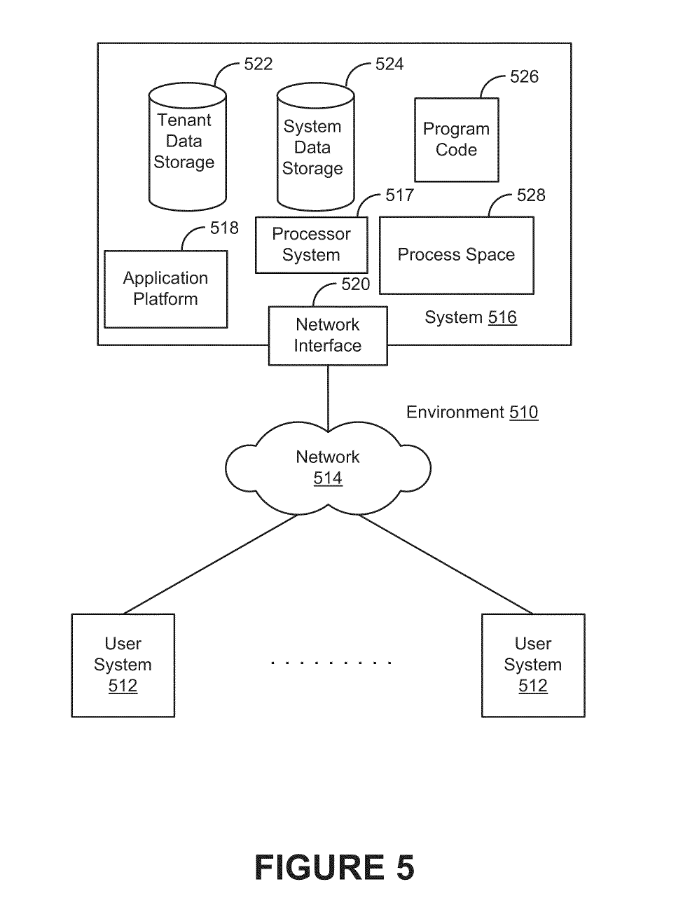

FIG. 5 illustrates a block diagram of an environment 510 wherein an on-demand database system might be used. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of or in addition to, those listed above.

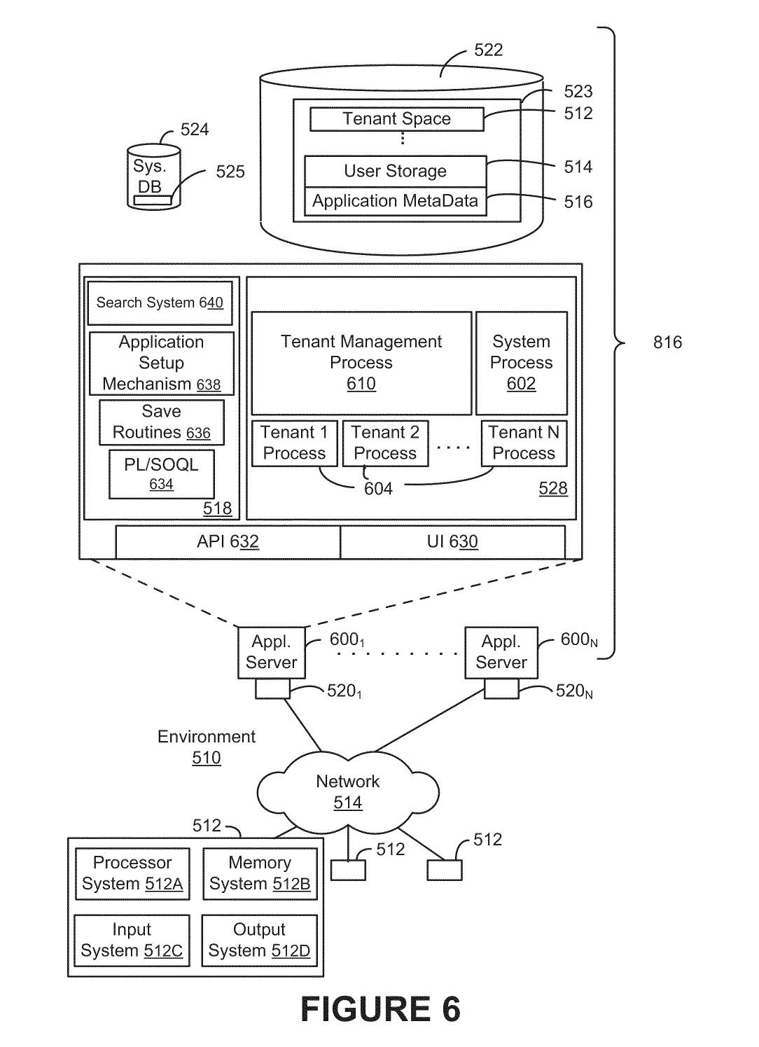

Environment 510 is an environment in which an on-demand database system exists. User system 512 may be any machine or system that is used by a user to access a database user system. For example, any of user systems 512 can be a handheld computing device, a mobile phone, a laptop computer, a work station, and/or a network of computing devices. As illustrated in FIG. 5 (and in more detail in FIG. 6) user systems 512 might interact via a network 514 with an on-demand database system, which is system 516.

An on-demand database system, such as system 516, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database system 516 may include an application platform 518 that enables creation, managing and executing one or more applications developed by the provider of the on-demand database system, users accessing the on-demand database system via user systems 512, or third party application developers accessing the on-demand database system via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may he supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Pentium® processor or the like. Similarly, system 516 (and additional instances of an MTS, where inure than one is present) and all of their components might be operator configurable using application(s) including computer code to run using a central processing unit such as processor system 517, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN. LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Jave™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-600_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may he any combination of one or more processors. Memory system 512B may he any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 Big-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might he organization-wide data shared or accessible by a plurality of users or all of the users for a given organization that is a tenant. Thus, there might be some data structures managed by system 516 that are allocated at the tenant level while other data structures might he managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product, comprising a non-transitory computer usable medium having a computer readable program code embodied therein, the computer readable program code adapted to be executed to implement a method for determining an amount of access to data, based on a role, the method comprising:
identifying a role of a user of a multi-tenant on-demand database system;
determining which data of the multi-tenant on-demand database system can be accessed by the user, based on the role; and
filtering a presentation of the data of the multi-tenant on-demand database system to the user, based on the data that can be accessed by the user.

2. The computer program product of claim 1, wherein the role of the user includes a position held by the user.

3. The computer program product of claim 1, wherein the role of the user is part of a role hierarchy structure.

4. The computer program product of claim 1, wherein the computer program product is operable such that the role of the user is determined when the user logs into the multi-tenant on-demand database system.

5. The computer program product of claim 1, wherein the data includes a plurality of records within a knowledge base of the multi-tenant on-demand database system.

6. The computer program product of claim 1, wherein the data of the multi-tenant on-demand database system is hierarchically arranged within one or more groups.

7. The computer program product of claim 1, wherein it is determined which data can be accessed by the user by identifying one or more associations between the role and one or more portions of the data.

8. The computer program product of claim 1, wherein the computer program product is operable such that the role of the user is associated with a tag.

9. The computer program product of claim 8, wherein it is determined that the user can access a data element if the data element includes the tag associated with the role of the user.

10. The computer program product of claim 1, wherein the computer program product is operable such that an administrator configures associations between the role of the user and one or more categories within one or more groups of the data.

11. The computer program product of claim 10, wherein the computer program product is operable such that the associations between the role of the user and the one or more categories within the one or more groups are stored in a mapping table.

12. The computer program product of claim 1, wherein the computer program product is operable such that the user access to one portion of the data is affected by the user access to another portion of the data.

13. The computer program product of claim 12, wherein the data that can be accessed by the user is determined by determining an exclusive combination of category groups of the data that include a tag associated with the user.

14. The computer program product of claim 1, wherein the computer program product is operable such that a first amount of data accessible by a first user cannot be greater than a second amount of data accessible by a second user with a role higher than the role of the first user within a role hierarchy.

15. The computer program product of claim 1, wherein the computer program product is operable such that associations between a role of a parent user and one or more categories within one or more groups of the data are inherited by subordinate roles within a role hierarchy.

16. The computer program product of claim 1, wherein presenting the data to the user includes displaying the data to the user.

17. The computer program product of claim 1, wherein presenting the data to the user includes allowing the user to perform one or more actions on the data.

18. The computer program product of claim 1, wherein the presentation of the data of the multi-tenant on-demand database system is filtered by only presenting to the user the data that can be accessed by the user.

19. A method, comprising:
identifying a role of a user of a multi-tenant on-demand database system;
determining which data of the multi-tenant on-demand database system can be accessed by the user, based on the role, utilizing a processor; and
filtering a presentation of the data of the multi-tenant on-demand database system to the user, based on the data that can be accessed by the user.

20. An apparatus, comprising:
a processor for:
identifying a role of a user of a multi-tenant on-demand database system;
determining which data of the multi-tenant on-demand database system can be accessed by he user, based on the role; and
filtering a presentation of the data of the multi-tenant on-demand database system to the user, based on the data that can be accessed by the user.

21. A method for transmitting code for use in a u -tenant database system on a transmission medium, the method comprising:
transmitting code for identifying a role of a user of a multi-tenant on-demand database system:
transmitting code for determining which data of the multi-tenant on-demand database system can be accessed by the user, based on the role, utilizing a processor: and
transmitting code for filtering a presentation of the data of the multi-tenant on-demand database system to the user, based on the data that can be accessed by the user.
